(19) United States
(12) Patent Application Publication
(10) Pub. No.: US 2003/0236045 A1
(43) Pub. Date: Dec. 25, 2003

(54) Crimped bath scrubber

(76) Inventor: Chen Ching-Chen, Chang-Hau Hsien (TW)

Correspondence Address: BRUCE H. TROXELL, SUITE 1404, 5205 LEESBURG PIKE, FALLS CHURCH, VA, 22041, US

(21) Appl. No.: 10/173,643

(22) Filed: Jun. 19, 2002

(51) Int. Cl. A47K 7/02; B32B 5/26

(52) U.S. Cl. 442/239; 15/227; 15/209.1; 15/208; 442/245; 442/268; 156/228

(57) ABSTRACT

Crimped bath scrubber including at least one blank material extending in a predetermined direction. The blank material is made of multiple first yarns and second yarns by a non-weaving measure. The blank material includes a substrate layer formed of the first yarns and a top layer overlaid on the substrate layer and formed of the second yarns. Corresponding portions of the first and second yarns are connected. The extending direction of the second yarns and the extending direction of the first yarns and the extending direction of the blank material respectively contains predetermined angles. The blank material is formed with multiple upward or downward bent crimped sections. The contained angle of each bent crimped section is less than 90 degrees, whereby the blank material is formed with multiple triangular solid spaces and the blank material is more spongy and fluffy so as to contain more water and bubble therein. The angles of the crimped sections provide better cleaning effect.

### BACKGROUND OF THE INVENTION

The present invention is related to a bath scrubber, and more particularly to a crimped bath scrubber the surface of which is waved and formed with multiple crimps. The bath scrubber has a solider shape and is able to contain more water and bubble therein.

Conventional bath scrubbers can be substantially divided into three types, that is, hairbrush type, woven article and integrally formed mesh article. The hairbrush type bath scrubber has hairs for contacting with human skin. A user often feels uncomfortable when using such bath scrubber. U.S. Pat. Nos. 4,980,943 and 6,109,070 disclose bath scrubbers made of woven articles. Such bath scrubber is made of yarns by weaving. The surface of such bath scrubber is spongy to achieve comfortable feeling when contacting with human skin. Moreover, such bath scrubber can contain more water and bath cream bubble. The yarns of such bath scrubber are quite soft. After a period of use, the loops of the bath scrubber will be unable to keep erect. Under such circumstance, the scrubber will lose its softness and water-containing function. Also, the loops are too soft to effectively clean the skin.

U.S. Pat. No. 5,916,408 discloses a bath scrubber made of unwoven mesh tube. The mesh tube is heated and passed through two rollers and pressed into a waved configuration. Such bath scrubber is made of plastic material and has a proper softness. The pressed shape of the plastic-made bath scrubber can be maintained. However, the bent sections formed by means of the pressing rollers have angles greater than 120 degrees. Therefore, the mesh tube can be hardly in a spongy state. Moreover, the waved sections are regularly arranged. As a result, even multiple layers are overlapped, the bath scrubber can be hardly sufficiently spongy for containing enough water and bubble therein.

### SUMMARY OF THE INVENTION

It is therefore a primary object of the present invention to provide a crimped bath scrubber having suitable softness and able to contain sufficient water and bubble therein.

It is a further object of the present invention to provide the above crimped bath scrubber having irregular waved sections spaced from each other by predetermined distance.

It is still a further object of the present invention to provide the above crimped bath scrubber in which the contained angle of the corner of each waved section is less than 90 degrees, whereby the bath scrubber is more spongy and elastic.

According to the above objects, the crimped bath scrubber of the present invention includes at least one blank material extending in a predetermined direction. The blank material is made of multiple first yarns and second yarns by a non-weaving measure. The blank material includes a substrate layer formed of the first yarns and a top layer overlaid on the substrate layer and formed of the second yarns. Corresponding portions of the first and second yarns are connected. The extending direction of the second yarns and the extending direction of the first yarns and the extending direction of the blank material respectively contain predetermined angles. The blank material is formed with multiple upward or downward bent crimped sections. The contained angle of each bent crimped section is less than 90 degrees, whereby the blank material is formed with multiple triangular solid spaces and the blank material is more spongy so as to contain more water and bubble therein. The angles of the crimped sections provide better cleaning effect.

The present invention can be best understood through the following description and accompanying drawings wherein:

### BRIEF DESCRIPTION OF THE DRAWINGS

FIG. 1 is a side view of the mesh tube of a conventional bath scrubber;

FIG. 2 is a perspective view of a preferred embodiment of the present invention;

FIG. 3 is a side view of the preferred embodiment of the present invention;

FIG. 4 is a side view showing that the preferred embodiment of the present invention is patterned;

FIG. 5 is a side view of another embodiment of the present invention; and

FIG. 6 is a perspective view of still another embodiment of the present invention.

### DETAILED DESCRIPTION OF THE PREFERRED EMBODIMENTS

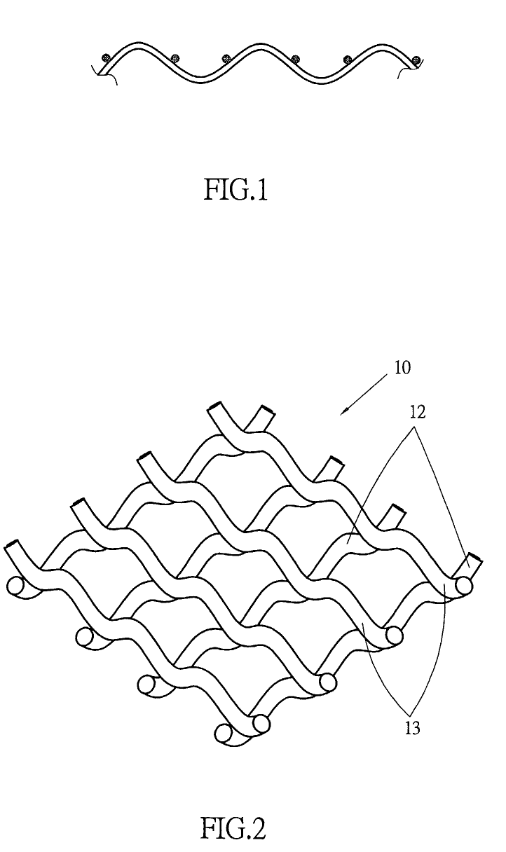

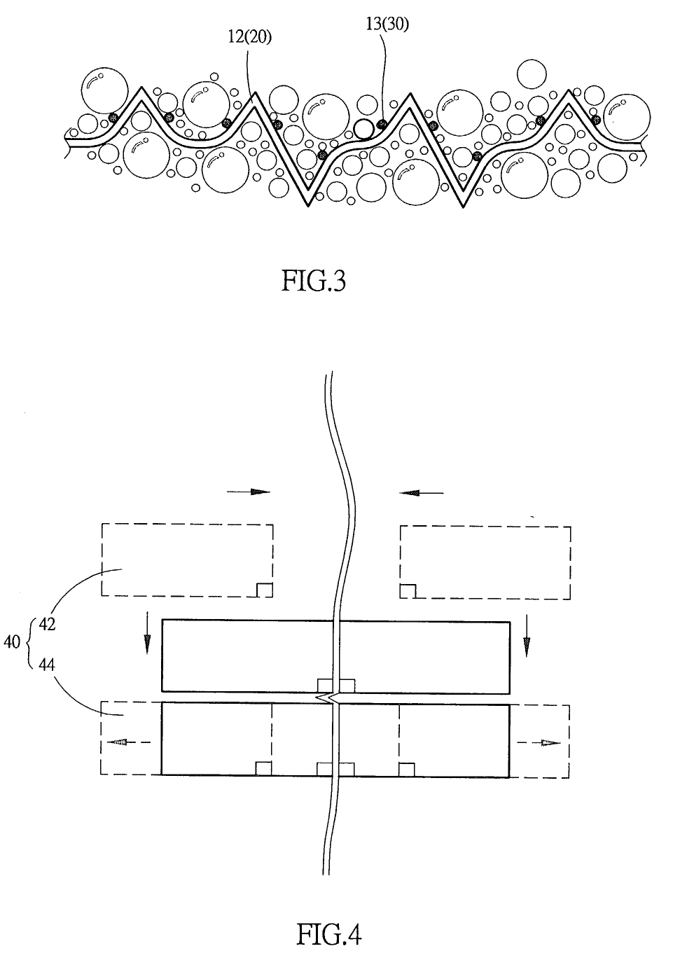

Please refer to FIGS. 2 and 3. The crimped bath scrubber of the present invention is made of a blank material 10 composed of multiple first yarns 12 and second yarns 13. The length of the blank material 10 can be freely extended.

The first yarns 12 are arranged at intervals. The direction of the first yarns 12 and the lengthwise direction of the blank material 10 contain a certain angle. The first yarns 12 form a substrate layer 20 with a certain thickness.

The second yarns 13 are arranged at intervals. The direction of the second yarns 13 and the lengthwise direction of the blank material 10 and the extending direction of the first yarns 12 respectively contain certain angles. The second yarns 13 form a top layer 30 with a certain thickness. The top layer 30 is overlaid on the substrate layer 20. The upper and lower corresponding portions of the first and second yarns 12, 13 are connected with each other, whereby the first and second yarns 12, 13 form the blank material 10 by a non-weaving measure.

Referring to FIG. 4, before manufacturing the bath scrubber with the blank material 10, the blank material 10 is first intermittently passed through a patterning mold 40 from upper side to lower side. The patterning mold 40 includes a set of upper clamp 42 and a set of lower clamp 44. When the lower clamp 44 clamps a lower portion of the blank material 10 and is fixed, the upper clamp 42 will clamp an upper portion of the blank material 10 and move downward by a short distance. At this time, a section of the blank material 10 between the upper and lower clamps 42, 44 is compressed. The upper and lower clamps 42, 44 are heated to a certain extent, whereby the section of the blank material 10 between the upper and lower clamps 42, 44 is thermally patterned in a compressed and bent state. Then the upper and lower clamps 42, 44 release the blank material 10 to achieve a crimped and waved blank material 10. The downward moving direction of the upper clamp 42 is parallel to the lengthwise direction of the blank material 10. Alternatively, the downward moving direction of the upper clamp 42 and the lengthwise direction of the blank material 10 can contain a certain angle which is preferably not greater than 45 degrees. Accordingly, the blank material 10 will have a waved appearance and the crimped section is deflected to achieve solider configuration.

When the blank material 10 is compressed, a part of the width thereof will be leftward bent, while another part will be rightward bent. Therefore, after patterned, the crimped sections of the blank material 10 will have an irregular shape with different bending direction and width. Moreover, the blank material 10 is compressed within a quite narrow space so that the contained angle of the corner of the bent section is quite small and less than 90 degrees. Furthermore, when the upper and lower clamps 42, 44 intermittently operate, the adjacent crimped sections are spaced from each other by a certain distance.

With the crimped sections having bending angles less than 90 degrees, the blank material 10 has multiple triangular conic solid spaces. Therefore, the blank material 10 is a spongy body with increased thickness and reduced density so as to contain more water and bubble therein.

The irregular crimped sections with acute angles rough the surface of the blank material 10 to enhance the cleaning effect. After at least two layers of blank material 10 are overlapped with each other (as shown in FIG. 5), the blank material 10 can still keep quite spongy without losing the elasticity and softness.

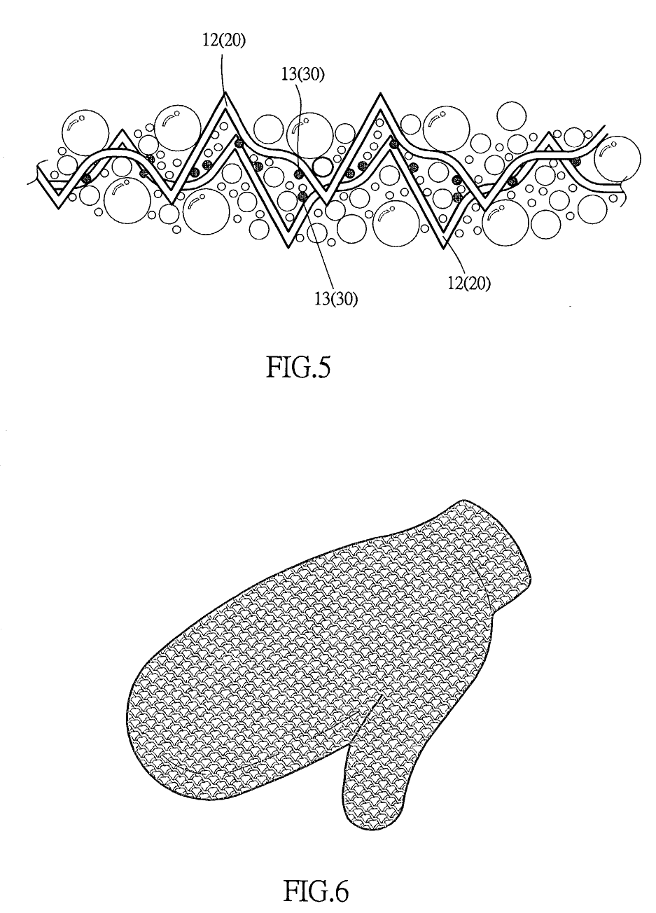

The blank material 10 can be previously made into a strip shape or cylindrical shape and then overlapped or compressed. Then the blank material 10 is bound or stitched into a sheet, a sphere or a glove (as shown in FIG. 6) as a cleaning means. Alternatively, the blank material can be fixed at an end of a handle for a user to clean his/her back. The blank material 10 is more spongy so that the cleaning means can be made of much less material. After expanded, the volume of the product is still considerably large.

The above embodiments are only used to illustrate the present invention, not intended to limit the scope thereof. Many modifications of the above embodiments can be made without departing from the spirit of the present invention.

What is claimed is:

1. Crimped bath scrubber comprising at least one blank material extending in a predetermined direction, the blank material being made of multiple first yarns and second yarns by a non-weaving measure, the blank material including a substrate layer and a top layer, the substrate layer being formed of the first yarns arranged at predetermined intervals, the top layer being overlaid on the substrate layer, the top layer being formed of the second yarns arranged at predetermined intervals, predetermined portions of the second yarns being connected with corresponding portions of the first yarns, the extending direction of the second yarns and the extending direction of the first yarns and the extending direction of the blank material respectively containing predetermined angles, the blank material being formed with multiple upward or downward bent crimped sections and waved, the contained angle of the corner of each bent crimped section being less than 90 degrees, whereby the blank material is formed with multiple triangular solid spaces and the blank material is more spongy so as to contain more water and bubble therein.

2. Crimped bath scrubber as claimed in claim 1, wherein some of the crimped sections are upward bent, while some others of the bent sections are downward bent.

3. Crimped bath scrubber as claimed in claim 1, wherein each two adjacent crimped sections are spaced by a predetermined distance.

4. Crimped bath scrubber as claimed in claim 1, wherein the blank material is cylindrical.

5. Crimped bath scrubber as claimed in claim 1, wherein the crimped sections are sequentially distributed substantially in the extending direction of the blank material.

6. Method for manufacturing a crimped bath scrubber, predetermined portions of a mesh blank material with a certain length being respectively clamped by two clamps spaced by a certain distance and having a certain temperature, then the clamps being moved toward each other to keep compressing a section of the blank material between the clamps for a period of time so as to thermally pattern the crimped sections, then the clamps releasing the blank material and restoring to their home positions.

7. Method for manufacturing a crimped bath scrubber as claimed in claim 6, wherein the moving direction of the clamps and the lengthwise direction of the blank material contain a predetermined angle.
